(19) United States
(12) Patent Application Publication
(10) Pub. No.: US 2006/0245365 A1
(43) Pub. Date: Nov. 2, 2006

(54) Apparatus and method for correlation and display of signaling and network events

(76) Inventors: John M. Monk, Monument, CO (US); Robert H. Kroboth, Peyton, CO (US)

Correspondence Address: AGILENT TECHNOLOGIES INC.;INTELLECTUAL PROPERTY ADMINISTRATION, LEGAL DEPT,, M/S DU404, P.O. BOX 7599, LOVELAND, CO, 80537-0599, US

(21) Appl. No.: 11/116,649

(22) Filed: Apr. 28, 2005

(51) Int. Cl. H04L 12/26

(52) U.S. Cl. 370/241

(57) ABSTRACT

A test and measurement system having two measurement systems. A first measurement system that monitors communication in a signaling protocol, while a second measurement system that monitors communication in a network protocol. A correlation system correlates the output of the first measurement system with the output of the second measurement system. A graphical user interface generates a display comparing at least one aspect of the output of the first measurement system with at least one aspect of the second measurement system based on the output of the correlation system.

### BACKGROUND OF THE INVENTION

Third-generation wireless communication systems (generally referred to as 3G systems) are typically defined by broadband packet-based transmission of data, including: text; voice; video; and multimedia, at data rates up to and possibly higher than 2 megabits per second (Mbps). 3G systems are currently being designed, built and placed into operation and eventually most wireless operators will offer some form of a 3G capable system.

One example of a 3G system is the Universal Mobile Telecommunications System (UMTS). UMTS is an evolving system being developed within the International Telecommunications Union (ITU) IMT-2000 framework. UMTS was generally conceived to be a follow-on network to the group special mobile (GSM) networks that dominate Europe. UMTS employs a 5 MHz channel carrier width to deliver significantly higher data rates and increased capacity compared with second-generation networks. This 5 MHz channel carrier provides optimum use of radio resources, especially for operators who have been granted large, contiguous blocks of spectrum—typically ranging from 2×10 MHz up to 2×20 MHz—to reduce the cost of deploying 3G networks. Universally standardized via the Third Generation Partnership Project (3GPP—see www.3gpp.org) and using globally harmonized spectrum in paired and unpaired bands, 3G/UMTS in its initial phase offers theoretical bit rates of up to 384 kbps in high mobility situations, rising as high as 2 Mbps in stationary/nomadic user environments. Symmetry between uplink and downlink data rates when using paired (FDD) spectrum also means that 3G/UMTS is ideally suited for applications such as real-time video telephony.

FIG. 1 is an idealized block diagram of an UMTS system based on the 3GPP release 1999. 3G systems, such as UMTS, generally have three constituent parts: a personal communication device 102, a radio access network 106 and a core network 108. The personal communication device 102 (termed user equipment(UE) in UMTS) generally comprises a cell phone or other personal communication device. The radio network 106 generally comprises on or more base stations 110n (termed a node-B in UMTS) coupled with one or more controllers 112n (termed a radio network controller (RNC) in UMTS). A base station 1 I On forms a communication path with the user equipment 102 under the direction of a controller 112n. The controller 112n in turn communicates with the core network 108. The core network 108 performs switching, billing and data service functions using various devices such as a Serving GPRS Support Node 114(SGSN) and a Mobile Switching Center/Visitor Location Register 114 (MSC/VLR).

Mobile data is transmitted on mobile interfaces, such as Uu, Iub, Iu-cs, lu-ps, GN, Gi, etc . . . There are generally two types of data that are communicated via such interfaces in a 3G system: circuit switched and packet switched. Circuit switched data generally comprises data destined for a circuit switched network including the PSTN network. Packet switched data generally comprises data transmitted in accordance with the Transmission Control Protocol/Internet Protocol (TCP/IP). In general, data is transmitted to and from the RNC's 112b using a mobile protocol, while the core network communicates both among itself and externally using packet switched data.

Test and measurement systems are available for monitoring and trouble-shooting various connections and devices in emerging 3G systems. In today's highly competitive telecommunications arena, customer demands for increased network reliability and performance must be balanced against the cost of operating and maintaining the network to support the higher level of desired service. A variety of network and signal test and measurement products are available from a variety of vendors that attempt to maximize the time and resources devoted to planning, troubleshooting, installing, and maintaining modern day packet and signaling networks.

The current trend in test and measurement instrumentation has been to offer separate solutions for signal and packet networks. For example, AGILENT TECHNOLOGIES, INC., assignee of the present application, offers two separate products: the SIGNALING ANALYZER for mobile telephony networks; and the NETWORK ANALYZER for packet switched networks. When a problem occurs, a user must first guess at which network is the root cause and start his analysis by selecting one or the other product. However, in many cases, what seems like a problem with the mobile network is actually a problem with the packet switched network and visa-versa.

The present inventors have recognized a need for new apparatus and methods facilitating a combined view of mobile and packet switched networks.

### BRIEF DESCRIPTION OF THE DRAWINGS

An understanding of certain embodiments of the present invention can be gained from the following detailed description of the invention, taken in conjunction with the accompanying drawings of which:

FIG. 1 is an idealized block diagram of an UMTS system based on the 3GPP release 1999.

FIG. 2 is a block diagram of a network analysis system upon which methods in accordance with a preferred embodiment of the present invention may be practiced.

FIG. 3 is a block diagram illustrating a system in accordance with an embodiment of the present invention.

FIG. 4 is a flow chart of a method in accordance with an embodiment of the present invention.

FIG. 5 is a sample of a display in accordance with an embodiment of the present invention.

### DETAILED DESCRIPTION

Reference will now be made in detail to embodiments of the present invention, some of which are illustrated in the accompanying drawings, wherein like reference numerals refer to like elements throughout. The detailed description which follows presents methods that may be embodied by routines and symbolic representations of operations of data bits within a computer readable medium, associated processors, general purpose personal computers and the like. These descriptions and representations are the means used by those skilled in the art effectively convey the substance of their work to others skilled in the art.

A method is here, and generally, conceived to be a sequence of steps or actions leading to a desired result, and as such, encompasses such terms of art as “routine,” “program,” “objects,” “functions,” “subroutines,” and “procedures.” The methods recited herein may operate on a general purpose computer or other network device selectively activated or reconfigured by a routine stored in the computer and interface with the necessary signal processing capabilities. More to the point, the methods presented herein are not inherently related to any particular device; rather, various devices may be used to implement the claimed methods. Machines useful for implementation of the described embodiments include those manufactured by such companies as AGILENT TECHNOLOGIES, INC. and HEWLETT PACKARD, as well as other manufacturers of computer and network test and measurement equipment (also referred to a network instruments).

With respect to the software described herein, those of ordinary skill in the art will recognize that there exist a variety of platforms and programming languages for creating software for performing the methods outlined herein. Embodiments of the present invention can be implemented using any of a number of varieties of programming languages, JAVA being one example? however, those of ordinary skill in the art also recognize that the choice of the exact platform and language is often dictated by the specifics of the actual system constructed, such that what may work for one type of system may not be efficient on another system. It should also be understood that the methods described herein are not limited to being executed as software on a microprocessor, but can also be implemented in other types of processors. For example, the methods could be implemented with HDL (Hardware Design Language) in an ASIC (application specific integrated circuits). In addition, the solution could span multiple computers, each performing a subset of the tasks.

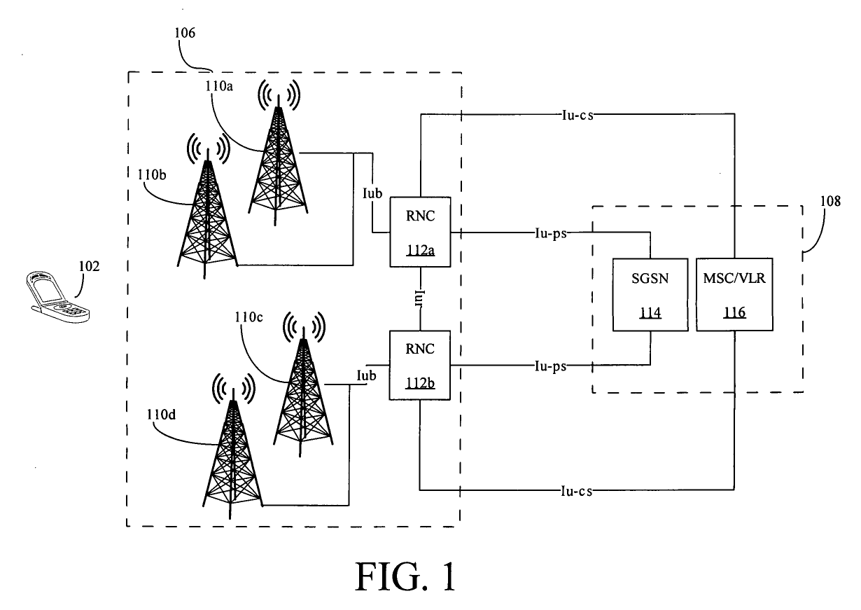

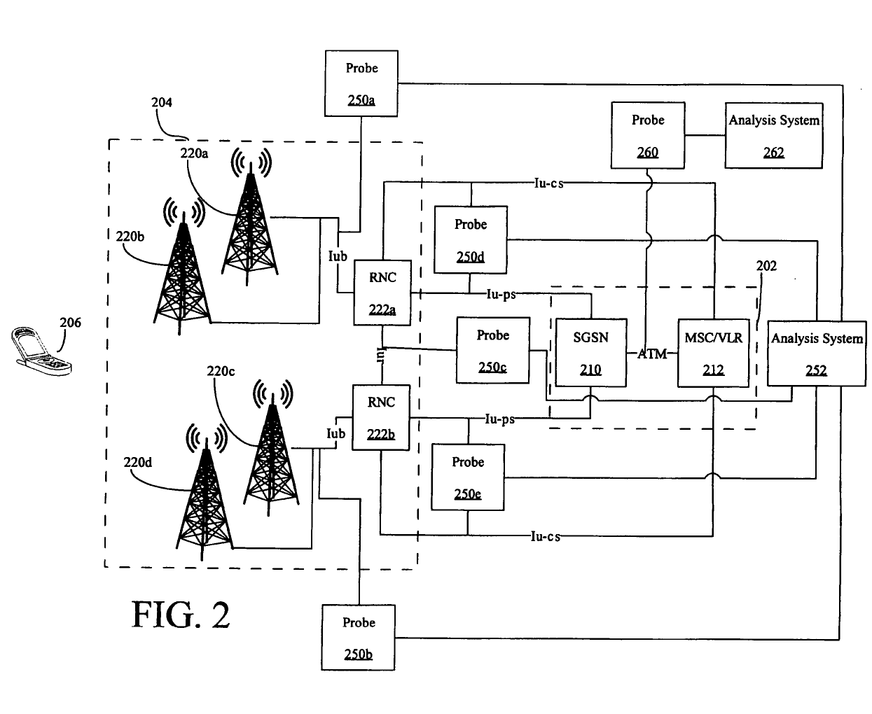

FIG. 2 is a block diagram of a network analysis system upon which methods in accordance with a preferred embodiment of the present invention may be practiced. More specifically, FIG. 1 illustrates a distributed test and measurement system applied to a UMTS network 200. The UMTS network 200 generally comprises Core Network (CN) 202, a UMTS Terrestrial Radio Access Network (UTRAN) 204 and User Equipment (UE)206. The main function of the CN 202 is to provide switching, routing and transit for user traffic which may includes voice, video, and data. The CN 202 also contains hardware and software for managing databases and performing network management functions. The UTRAN 204 provides the air interface access method for UE 202. The UE 202 generally comprises a cell phone or other personal communication device. In the configuration shown in FIG. 2, the CN 202 generally comprises: one or more serving GPRS support nodes (SGSN) 210 and on or more mobile switching centers 212. The UTRAN 204 generally comprises one or more Node-B's 220n and one or more RNC's 222n.

The connections among and between the various constituent parts of a UMTS network 200 are facilitated by interfaces. For example, the air interface between the node B's 220n and the user equipment 106 is refered to as a Uu interface and generally conforms to the WCDMA air interface. Similarly, communication between node B's 220n and the RNC's 222n are facilitated by lub interfaces, a generally open standardized interface. Unlike GSM, UMTS specifies an interface between RNC's 212n, termed the Iur interface. The interface between the RNC's 222n and the core network are generally termed an Iu interface. In at least the first iteration of the UMTS standard, separate Iu interfaces for circuit switched and packet switched connections are used, termed Iu-cs and Iu-ps respectively. At least in the initial versions of UMTS, each of the cited interfaces are based on asynchronous transfer mode (ATM) technology.

Probes 250n, such as the probes in the Agilent Distributed Network Analyzers family of products, monitor communications using a signaling protocol sent within the UMTS 200. One example of a signaling protocol is the Access Link Control Application Part protocol (ALCAP). Generally, the probes 250n passively and actively measure and gather messages passedt over the various interfaces, such as the IUB, IU, and IUR link. Thus, the probe 250a monitors the Iub interface between the RNC 222a and the node-B's 220a and 220b. The probe 250b monitors the Iub interface between the RNC 222b and the node-B's 220c and 220d. The probe 250c monitors the Iur interface between the RNC 222a and the RNC 222b. Lastly the probe 250d and 250e monitor the Iu interfaces between the RNC's 222a and 222b, respectively, with the core network 202. An analysis system, 252 receives messages from the probes 250n, analyzes the messages and provides information related to the signaling operation of the UMTS system 100. The analysis system may, for example, comprise an AGILENT SIGNALING ANALYZER. Analysis systems from other sources may be utilized.

The AGILENT TECHNOLOGIES' SIGNALING ANALYZER provides a distributed testing and analysis solution that maximizes the time and resources devoted to planning, troubleshooting, installing, and maintaining modern day networks. The modular design and flexibility of Signaling Analyzer solutions allows technology teams to identify potential problems and resolve faults quickly and effectively—with product configurations to exactly match engineers' differing needs. In particular, the Signaling Analyzer—Realtime (J7326A) enables key personnel to see network problems as they occur and turns what can be an overwhelming amount of diagnostic data into usable information. For maximum interface flexibility, the Signaling Analyzer—Realtime uses the same well-proven J6801A data acquisition module with hot-swappable Line Interfaces as Agilent's other distributed network analysis solutions. Alternatively, the Signaling Analyzer—Software Edition (J5486B) can be used off-line for post-capture analysis.

Probe 260, such as the probes in the Agilent Distributed Network Analyzer family of products, monitors packet switched messages sent within the UMTS 200. In the idealized architecture illustrated in FIG. 2, one example of packet communication is that between the MSC 212 and SGSN 210. An analysis system, 262 receives messages from the probes 260n, analyzes the messages and provides information related to the packet switched operation of the UMTS system 100. The analysis system may, for example, comprise an AGILENT NETWORK ANALYZER.

The Agilent Network Analyzer software is a powerful protocol analysis tool designed to troubleshoot and analyze a LAN, WAN, or ATM networks. The Agilent Network Analyzer software is a protocol analysis tool used to monitor network performance, capture and decode network traffic, and gather statistical data such as utilization, error activity, protocol and traffic distributions, and other important network information. The Agilent Network Analyzer also facilitates access and control of Line Interface Modules (LIMs)—the interface to the network under test—for all major LAN and WAN/ATM interfaces—and connected and/or networked DNAs. Offline analysis capabilities are provided that that allows the viewing and analyze of previously captured network traffic and statistics without connecting to the network under test. Overall the Network Analyzer software facilitates: baselining network performance; preventing network problems before they affect users; resolving network problems quickly and effectively; optimizing network performance.

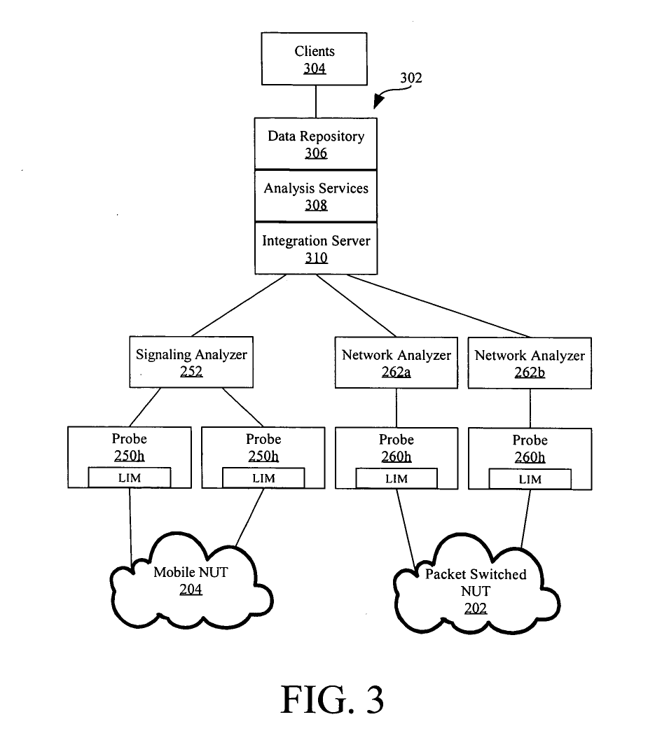

FIG. 3 is a block diagram illustrating a system in accordance with an embodiment of the present invention. FIG. 3 illustrates two probes 250h and 250i monitoring a mobile network under test 204 and two additional probes 260h and 260i monitoring a packet switched network under test 202. A signaling analyzer 252 collects data from the probes 250h and 250i while two Network Analyzers 262a and 262b collect data from the probes 260h and 260i, respectively. Each analyzer creates a variety of measurements describing the signals being monitored. Such measurements generally comprise data and context. The context may be a time stamp with an identification of the analyzer producing the measurement. The data may comprise raw data captured from the network under test, either using the Network Analyzer to capture packet switched data from the core network or using the Signaling Analyzer to capture call trace/call state information from the mobile network.

The signaling analyzer 252 and the network analyzers 262n transmit data to a correlation system 302. The correlation system 302 may comprise a personal computer or other computing devices, such as a dedicated server, or network analyzer, configured to operate in accordance with the present teachings. The correlation system 302 includes an integration server 310 that receives data from the probes 252n and 260n, filters the data to extract relevant data, correlates signaling events with packet switched events and deposits the relevant data into a data repository 306. An analysis service 308 maps the data into a format for a two-dimensional (or three-dimensional) display. A client 304 retrieves the correlated and mapped data from the data repository 306 and generates a display that facilitates a unified view of signaling and packet switched events.

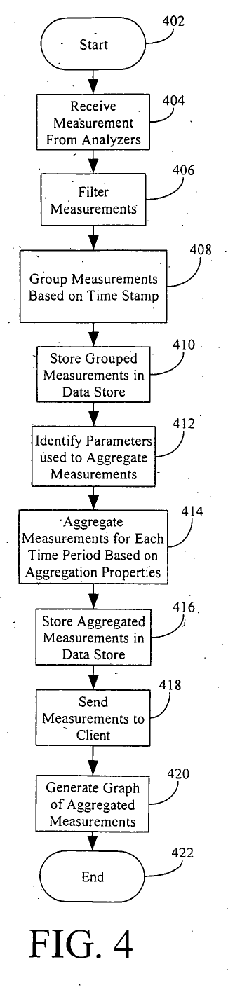

FIG. 4 is a flow chart of a method in accordance with an embodiment of the present invention. The method starts in step 402. Next in step 404, the computer 302 is configured to receive measurements from connected analyzers, such as the analyzers 250n and 260n—see FIG. 3. As noted, such measurements typically comprise context and data. Context may, for example, include a time stamp, an indication of the analyzer supplying the measurements, an indication of where the data was obtained, an identification of an event type being measured, or any combination thereof. Data typically comprises a scalar value representative of the occurrence of an event. The data could represent the fact that the event occurred (or the number of such occurrences) or a magnitude associated with the event.

The type of measurements supplied will depend on the configuration of the analyzers supplying the measurements. However, with respect to the present invention, it is to be noted that the events reported by signaling analyzers, e.g. analyzers 250n, differ from the types of events reported by network analyzers, e.g. analyzers 260n. For example, typical signaling measurements may include: dropped calls, setup failures, network out of order, resource unavailable, no route to transit network, etc. Similarly, by way of example, typical network measurements may include: CRC errors, collisions, frame check sums, % utilization, loss, jitter, runts, jabbers, retransmissions, etc.

Next in step 406, the measurements are filtered to eliminate measurements that are not of interest. Such filters may be set up by a user of the system or provided as a standard set. Some examples of measurements that a user may wish filtered out include: FP, Iub signaling line, Iub signaling equipment, RANAP/ALCAP/NBAP.

Next in step 408, measurements are grouped based on the time stamp of the measurements. The parameters of the grouping, e.g. interval, may be defined by the user. This process creates a data structure organized by time interval that collects (e.g. correlates) the signaling and network measurements for that time interval. Thereafter, in step 410, the groups of measurements are stored in the data store 306 (see FIG. 3).

Next in step 412, the parameters to be used to aggregate the various measurements are identified. Thereafter, in step 414, the measurements in each interval are aggregated, based on the identified aggregation parameters, to produce a single value representative of the signaling measurements and a single value representative of the network measurements . In general, there will be two sets of aggregations parameters: one for signaling measurements and one for network measurements. By way of example, the aggregation parameters may specify additional filters to select one or more measurement types of interest. The parameters may also specify how to combine the various measurements in each interval to arrive at a single value. For example a user may wish to compare the number of dropped calls (a signaling measurement) vs. the number of CRC errors (a network measurement). In this case the parameters would filter out non-relevant measurements and specify simple addition of occurrences to arrive at the representative values. It may also prove interesting to combine several measurements either with simple addition or using weighted values to create the representative value.

In step 416, the aggregated measurements, e.g. the representative values, are stored (along with their time stamp or some other indication of the time interval being represented) in the data repository 306. Thereafter, the measurements are sent to a client 304 for display in a GUI in step 420. Generally, the display will comprise two stacked line graphs, with one line representative of signaling measurements and one line representative of network measurements.

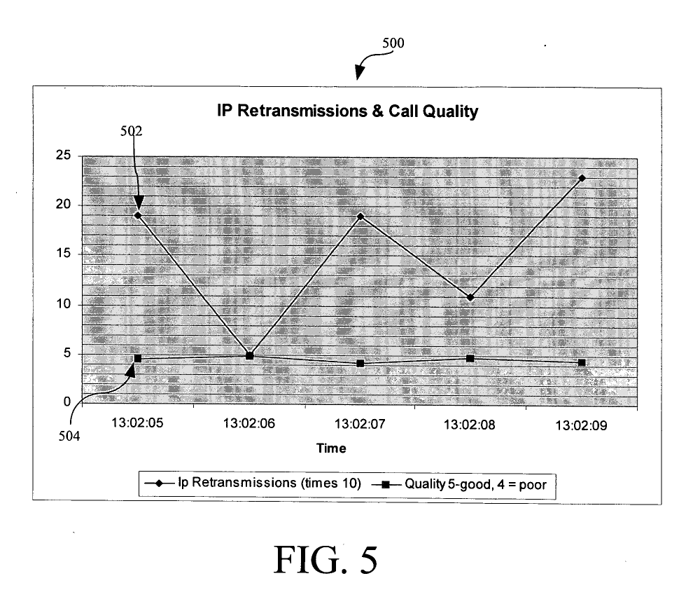

FIG. 5 is a sample of a display 500 in accordance with an embodiment of the present invention. A first line 502 represents the number of IP retransmissions, on a packet switched network, for each time interval. A second line 504 represents the quality of service of a mobile network. The quality of service measurement is typically an aggregated measurement based on other measurements. The values used to plot both line 502 and 504 have been normalized to fit on the same graph. The Ip retransmissions measurements have been divided by 10, while the quality of service measurements have been normalized such that “5” represents the upper end of the measurement range, while “4” represents the lower end of the measurement range.

Although an embodiment of the present invention has been shown and described, it will be appreciated by those skilled in the art that changes may be made in these embodiments without departing from the principles and spirit of the invention, the scope of which is defined in the claims and their equivalents.

For example, while the present invention has been described with reference to probes and analyzers available from Agilent Technologies Inc., the assignee of the present application, the invention is not limited thereto, but is applicable to all test and measurement systems and in particular headless probes and headless network analyzers.

What is claimed is:

1. A test and measurement system comprising:
a first measurement system that monitors communication in a signaling protocol;
a second measurement system that monitors communication in a network protocol;
a correlation system that correlates the output of the first measurement system with the output of the second measurement system; and
a graphical user interface that generates a display comparing at least one aspect of the output of the first measurement system with at least one aspect of the second measurement system based on the output of the correlation system.

2. A test and measurement system, as set forth in claim 1, wherein the correlation system correlates the output of the first measurement system with the second measurement system based on time.

3. A test and measurement system, as set forth in claim 1, wherein the graphical user interface generates a chart having a first line representing at least one aspect of the output of the first measurement system and a second line representing at least one aspect of the second measurement system.

4. A test and measurement system, as set forth in claim 3, wherein the first line represents a single measurement from the first measurement system and a second line represents a single measurement from the second measurement system.

5. A test and measurement system, as set forth in claim 3, wherein the first line represents an aggregate of measurements from the first measurement system and a second line represents an aggregate of measurements from the second measurement system.

6. A test and measurement system, as set forth in claim 1, wherein the first measurement system comprises:
at least one probe connected to a network transmitting data using a signaling protocol; and
a signaling analyzer that receives data from the at least one probe and outputs measurements to the correlation system.

7. A test and measurement system, as set forth in claim 1, wherein the second measurement system comprises:
at least one probe connected to a packet switched network; and
a network analyzer that receives data from the at least one probe and outputs measurements to the correlation system.

8. A test and measurement system comprising:
first measurement means monitoring communication in a signaling protocol and outputting measurements;
second measurement means monitoring communication in a network protocol and outputting measurements;
correlation means correlating measurements from the first measurement means with measurements from the second measurement means; and
display means generating a display comparing measurements from the first measurement means with measurements from the second measurement system based on the output of the correlation system.

9. A test and measurement system, as set forth in claim 8, wherein the correlation means correlates the output of the first measurement means with the second measurement means based on time.

10. A test and measurement system, as set forth in claim 8, wherein the means generates a chart having a first line representing an aspect of the measurements from the first measurement means and a second line representing an aspect of the measurements from the second measurement means.

11. A test and measurement system, as set forth in claim 10, wherein the first line represents a single measurement type from the first measurement means and a second line represents a single measurement type from the second measurement means.

12. A test and measurement system, as set forth in claim 10, wherein the first line represents an aggregate of measurements from the first measurement means and a second line represents an aggregate of measurements from the second measurement means.

13. A test and measurement system, as set forth in claim 8, wherein the first measurement means comprises:
at least one probe connected to a network transmitting data using a signaling protocol; and
a signaling analyzer that receives data from the at least one probe and outputs measurements to the correlation means.

14. A test and measurement system, as set forth in claim 8, wherein the second measurement means comprises:
at least one probe connected to a packet switched network; and
a network analyzer that receives data from the at least one probe and outputs measurements to the correlation means.

15. A method of display comprising:
generating first measurements related to communication utilizing a signaling protocol;
generating second measurements related to communication over a packet switched network;
correlating the first measurements with the second measurements; and
displaying a chart comparing the first measurements with the second measurements.

16. A method of display, as set forth in claim 15, wherein the step of correlating comprises forming a pair of values for each of a plurality of time intervals wherein one value in the pair represents the first measurements occurring during a time interval and the other value in the pair represents the second measurements occurring during the same time interval.

17. A method of display, as set forth in claim 16, wherein the step of displaying comprises plotting the pair of values on a graph for each of the plurality of time intervals.

18. A method of display, as set forth in claim 16, wherein the pair of values are formed by aggregating several measurement types from the first and second measurements.

19. A method of display, as set forth in claim 16, wherein the pair of values are formed by selecting a single measurement type from the first and second measurements.
